(19) United States
(12) Patent Application Publication
(10) Pub. No.: US 2016/0117518 A1
(43) Pub. Date: Apr. 28, 2016

(54) File Encryption/Decryption Device And File Encryption/Decryption Method

(71) Applicant: BEIJING QIHOO TECHNOLOGY COMPANY LIMITED, Beijing (CN)

(72) Inventors: Jianfeng CAO, Beijing (CN); Chenguang ZHOU, Beijing (CN); Jiang ZHAO, Beijing (CN)

(21) Appl. No.: 14/896,299

(22) PCT Filed: Jun. 4, 2014
(86) PCT No.: PCT/CN2014/079167

§ 371 Date: Dec. 4, 2015

(30) Foreign Application Priority Data
Jun. 7, 2013 (CN) 201310226540.7

(51) Int. Cl. G06F 21/62; H04L 9/30

(52) U.S. Cl. CPC G06F 21/6209; H04L 9/30

(57) ABSTRACT

Provided are a file encryption and decryption device and file encryption and decryption method. The encryption device comprises: one or more non-transitory computer readable medium configured to store computer-executable instruction; at least one processor to execute the computer-executable instruction to cause: selecting important data in a source file to be encrypted; receiving the important data selected by the selector and encrypting the important data according to a pre-set encryption algorithm; receiving the encrypted important data provided by the encryptor and storing the encrypted important data at a specified first location; a deletion component for deleting the unencrypted important data in the source file; generating encryption information according to the above encryption procedure and storing the encryption information at a specified second location, the encryption information at least including the original location of the important data in the source file.

### TECHNICAL FIELD

The present invention relates to the field of computer application technology, and particularly to a file encryption method and a decryption method corresponding to the file encryption method. The present invention also relates to a file encryption device and a decryption device corresponding to the file encryption device.

### DESCRIPTION OF RELATED ART

File encryption is a technique for encrypting data written to a storage medium on the operating system layer in accordance with requirements.

File encryption can be divided into two categories according to encryption approaches: one is a file encryption function built in the system; and the other is an encryption function implemented by adopting encryption algorithm.

Under general circumstances, encryption of data means converting plaintext into ciphertext through encryption algorithm and encryption key, and decryption means restore the ciphertext to the plaintext through decryption algorithm and decryption key. Specifically, protection of data is to process a file where the data is located according to a certain algorithm to convert the file into a section of codes unreadable, the original contents of the file can be showed only after a corresponding key is inputted, so as to achieve the purpose for protecting the data of the file from being illegally stolen and read. As shown in FIGS. 1 and 2, the encryption and decryption of the whole file both are realized by inputting a key into an algorithm.

In addition, with increasing attention being paid to the protection of the personal privacy, more and more people need to protect their own private files. Especially with the prevalence of intelligent mobile terminals, the terminals are no longer just a simple communication tool, but might save various important files therein. When these important files are encrypted, the following way is generally adopted: firstly a file or a folder needed to be encrypted is selected and then encryption will be performed through an encryption button set by the system, so as to ensure the security of information of the data.

It can be understood that, the above mentioned encryption method is used for encrypting the whole file or folder. The larger the stored file or folder is, the longer it needs to take to encrypt it, and correspondingly the longer it will take to decrypt it. When the approach to perform encryption process on a file by a user requires a higher performance in the encryption process capability, but the apparatus used has a lower computing capability, for example, when the photographs taken in a mobile terminal is encrypted therein, the requirements of the user especially cannot be fulfilled by this kind of encryption approach. In this circumstance, it should also be considered that, when too many system resources are used for the encryption computation which needs to occupy a lot of computing capability, the running of other files will be affected by the encryption operation, resulting in an overall reduction in the response speed of the system.

How to provide a file encryption/decryption method and an encryption/decryption device, which while effectively achieving the requirements of the user on the high performance of the file encryption approach, will not affect the response speed of the system, becomes a problem needed to be solved.

### BRIEF SUMMARY OF THE INVENTION

In order to solve the above technical problem, the present disclosure provides a file encryption/decryption method and an encryption/decryption device, which while fulfilling the requirements of the user on the performance of file encryption, can also increase the response speed of the system.

The present disclosure provides a file encryption method including:

determining a source file to be encrypted;

selecting important data in the source file;

encrypting the important data according to a pre-set encryption algorithm;

storing the encrypted important data at a specified first location;

deleting the unencrypted important data from the source file;

storing encryption information at a specified second location, the encryption information at least including the original location of the important data in the source file.

The present disclosure also provides a file decryption method including:

reading an encrypted file in which only important data has been encrypted;

acquiring the encrypted important data from a first location;

reading encryption information through a second location, the encryption information at least including the original location of the important data in the source file;

performing decryption according to the encryption information and locating the decrypted important data at the original location of the important data in the source file provided by the encryption information;

storing the restored source file.

The present disclosure also provides a file encryption device including:

a selector for selecting important data in a source file to be encrypted;

an encryptor for receiving the important data selected by the selector and encrypting the important data according to a pre-set encryption algorithm;

an encrypted data storage component for receiving the encrypted important data provided by the encryptor and storing the encrypted important data at a specified first location;

a deletion component for deleting the unencrypted important data in the source file;

an encryption information generate and storage component for generating encryption information according to the above encryption procedure and storing the encryption information at the specified second location, the encryption information at least including the original location of the important data in the source file.

The present disclosure also provides a file decryption device including:

an encrypted file reader for reading an encrypted file, in the encrypted file only important data being encrypted;

an encryption information reader for reading encryption information from a specified location, the encryption information at least including the original location of the important data in the unencrypted source file;

an encrypted data reader for reading the important data in the encrypted file from the specified location;

a decryptor for receiving the important data read by the encrypted data reader and decrypting the encrypted important data by using a decryption algorithm corresponding to the encryption algorithm of the encrypted important data;

a decrypted data replacing component for receiving the encryption information read by the encryption information reader and according to the original location of the important data in the unencrypted source file, provided in the encryption information, replacing the decrypted important data back into the original location.

According to a specific implementation of a file encryption and decryption method and an encryption and decryption device provided by the present disclosure, the present disclosure discloses the following technical effects: According to the present disclosure, by selecting the important data in a file and encrypting the determined important data, a local encryption is realized only for the important data in the file selected by the user by an encryption operation, rather than encrypting the whole file or folder, and when decrypting, whether there is an encrypted important data in the source file is needed to be known and the storage location of the encrypted data is needed to be known, thereby the difficulty of the decryption is increased. In addition, the present disclosure only perform encryption for the important data portion in a file, which greatly reduces the data needed to be encrypted, which can significantly improve the encryption speed and encryption efficiency, reduce the amount of encryption computation of the apparatus and enable an apparatus with lower data processing capability, e.g. a mobile terminal, perform encryption process rapidly.

### BRIEF DESCRIPTION OF THE DRAWINGS

In order to explain the technical solution in the embodiments of the present disclosure or the prior art more clearly, the drawings needed to be used in the description of the embodiments or the prior art will be briefly introduced below. Obviously, the drawings in the following description are merely some embodiments disclosed in the present disclosure. For those ordinary skilled in the art, other drawings can also be obtained from these drawings.

FIG. 1 is a schematic diagram of the file encryption method in the prior art;

FIG. 2 is a schematic diagram of the file decryption method in the prior art;

FIG. 3 is a flowchart of an embodiment of a file encryption method provided by the present invention;

FIG. 4 is a flowchart of an embodiment of a file decryption method provided by the present invention;

FIG. 5 is a block diagram of an embodiment of a file encryption device provided by the present invention;

FIG. 6 is a block diagram of an embodiment of a file decryption device provided by the present invention;

FIG. 7 shows a block diagram of an intelligent electronic apparatus for performing the method according to the present invention; and

FIG. 8 shows a schematic diagram of a storage unit for holding or carrying program codes for realizing the method according to the present invention.

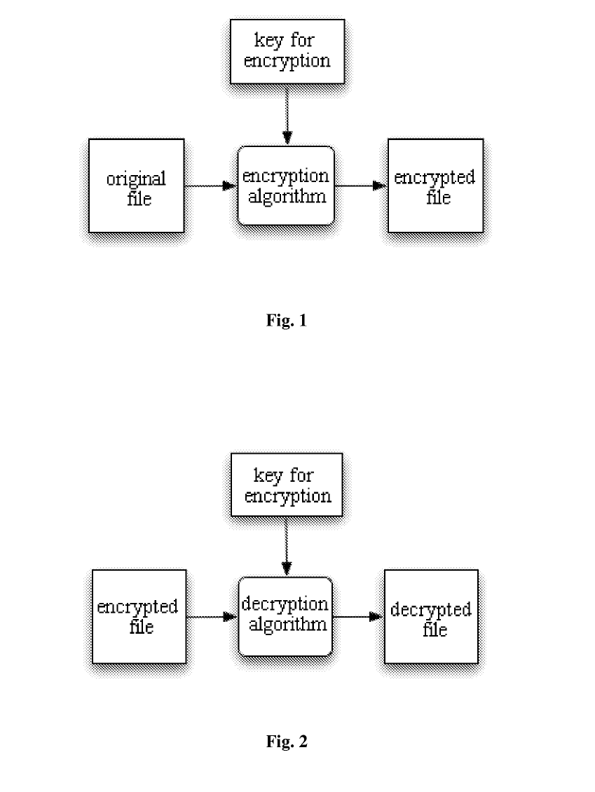

### DETAILED DESCRIPTION OF THE INVENTION

Below, the technical solution in the embodiments of the present invention will be described clearly and thoroughly in conjunction with the drawings in the embodiments of the present disclosure. Obviously, the described embodiments are merely a part of embodiments of the present disclosure, rather than all the embodiments. All the other embodiments obtained by those ordinary skilled in the art based on the embodiments in the present disclosure all belong to the protection scope of the present disclosure.

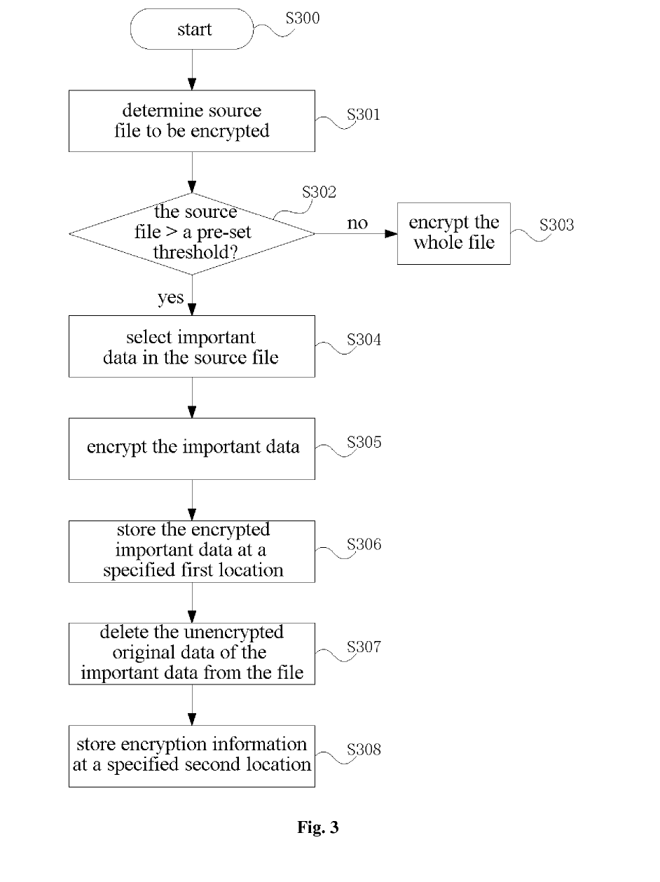

Refer to FIG. 3, which is a flowchart of an embodiment of a file encryption method provided by the present disclosure. In the present embodiment, the method includes the following steps:

Step S300 is starting.

Step S301 is determining a source file to be encrypted.

The determining a source file to be encrypted can be determining in accordance with the importance of the file per se, or determining in accordance with requirements of a user on the importance of the file.

Step S302 is judging whether a size of the file is larger than a pre-set threshold.

In this step, after determining the source file to be encrypted, the size of the source file can be compared with a pre-set threshold and different operations will be performed in accordance with the result of the comparison. The threshold can be a capacity value of the capacity of the memory occupied by the file or folder. If the size of the file is smaller than the pre-set threshold, the process proceeds to step S303.

Step S303 is directly encrypting the whole file rather than encrypting a certain part of data in the file. Because due to the smaller memory space occupied by the file, time expense of the encryption thereof is less, it is no longer needed to select important data of the file to encryption. On the contrary, if the size of the file is larger than the pre-set threshold, the process proceeds to step S304, in which a step of selecting important data in the file is performed. The selected important data in the file is targetly encrypted, so as to save the time for encryption and decryption.

Step S304: selecting important data in the source file.

In the procedure of specifically realizing the present step, the important data may relate to data in a system file; or data in financial files, production files, sales files, marketing files, human resources files, etc. selected by the user. The important data may also be data of personal files of the user such as photographs, videos, logs, etc. The selecting method of the important data can be implemented in many ways. Only a few of examples of the specific implementations will be given below, in order to explain the step S304 of the present disclosure.

(a) A first specific implementation of selecting the important data in the source file:

The method for selecting the important data in the file is to recognize a type of the file and select a fixed location of the important data in the file according to the type of the file. The type of the file is also referred to as a file format. Commonly used are JPG, PNG, EXE, COM, BMP, GIF, WMV, APE, RMVB, FLV, SWF, TXT, CPP, ASM, etc. There is information such as codes and data included in the file and the information is stored in a file header by segments, the file header being used for describing an overall structure of the file. For example, in the EXE file, the header file thereof generally includes code segments, data segments, stack segments and extended segments, etc. Execution instructions of the computer i.e. operation instructions to be performed by a CPU are stored in the code segments. Data to be used by the CPU is stored in the data segments. Information related to registers, etc. is stored in the stack segments. The header information in a JPG file is used for parsing a JPG. However, for parsing, a data length of the JPG is variable and after encrypted, it cannot be properly read by other picture browsers. In a PNG file, important information of the file is protected through a file header as well. However, the data length of the important information of the file header is fixed and after encrypted, it cannot be properly read by other picture browsers as well. After the type of the file is determined, the fixed location of the important data in the file is selected according to the file header of the file and then these important data are encrypted according to the fixed location.

(b) A second specific implementation of selecting the important data in the source file:

The method for selecting the important data in the file is to receive specifying of the important data of the file by the user. If the file is a text file, a certain page or a certain paragraph in the text file can be specified by the user as the important data, the contents of the page will be encrypted through the specified page number, or an area of the paragraph will be computed by specifying the starting location and the ending location of the paragraph, and the important data specified by the user will be exacted by calling an exacting function, and the exacted important data will be encrypted. If the file is a graphic file, a certain important part or certain important parts of the graphics in the graphic file can be selected by the user and the intercepted important data will be encrypted by calling the screenshots function.

Step S305: encrypting the important data according to a pre-set encryption algorithm.

The extracted important data is encrypted. The encryption approaches can be encrypting the important data by adopting the encryption algorithm through a pre-set key. In fact, there are a lot of encryption approaches, which are not described here.

Step S306: storing the encrypted important data at a specified first location.

The important data, after being encrypted, is stored at a specified first location. The first location can be a specified location in the source file or a specified location of another file. The specified location can be located at a side of the apparatus per se or at a server side. That is, the specified location can be any location and the first location and a second location may coincide.

Step S307: deleting the unencrypted original data of the important data from the file.

After the encrypted important data is stored, the original important data in the file will be deleted, so that when the original file is opened, the important data therein will be invisible, which avoids the leakage of the important data.

Step S308: storing encryption information at a specified second location, the encryption information at least including the original location of the encrypted important data. The specified second location where the encryption information is stored may be the header of the source file.

In addition, the encrypted important data and the data other than the important data in the source file can be encapsulated together as an encrypted file and the source file can be substituted with the encrypted file. Alternatively, only the data other than the encrypted important data is encapsulated as an unencrypted file and the source file is substituted with the unencrypted file.

Since in the encryption method provided by the present disclosure, by selecting an important data portion in a source file, the important data portion is encrypted, i.e., locally encrypted, the method can achieve better encryption effect than the whole source file being encrypted by adopting a unified encryption approach. Because when decrypting, whether there is an encrypted important data in the source file is needed to be known and the storage location of the encrypted data is needed to be known, the difficulty of the decryption is increased. In addition, the present disclosure only perform encryption for the important data portion in a file, which improves the encryption efficiency, and can realize a function of performing encryption process rapidly for an apparatus with lower data processing capability.

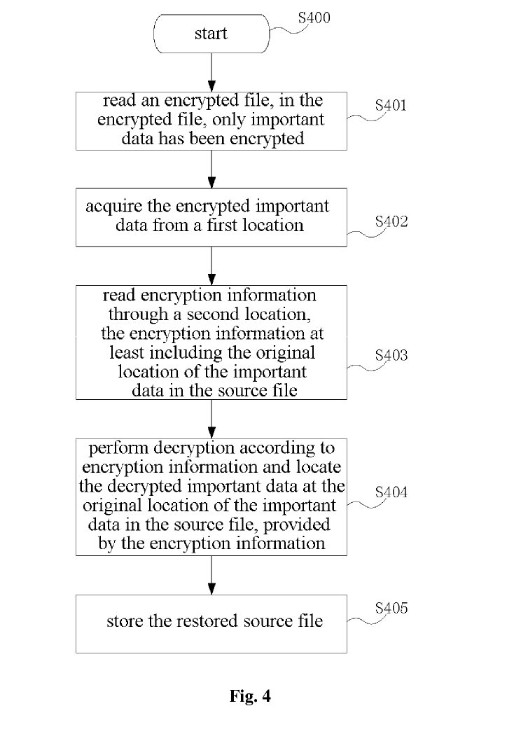

The embodiment of a file encryption method of the present disclosure has been disclosed above. Corresponding to the embodiment of the encryption method, the present disclosure also discloses an embodiment of a file decryption method. With reference to FIG. 4, FIG. 4 is a flowchart of the embodiment of a file decryption method of the present disclosure;

Step S400 is the decryption starting;

Step S401 is reading an encrypted file, in the encrypted file only important data has been encrypted;

Step S402 is acquiring the encrypted important data from a first location;

Step S403 is reading encryption information through a second location, the encryption information at least including the original location of the important data in the source file;

Step S404 is performing decryption according to the read encryption information and locating the decrypted important data at the original location of the important data in the source file, provided by the encryption information;

Step S405 is, storing the restored source file.

The above steps are realized according to the encryption information stored in the specified second location of the file in the encryption method. The second location can be a specified location of the source file, e.g., the header of the source file, or a specified location of another file. The specified location can be located at the local side or at a server side. If it is located at the header of the source file, upon the decryption, the decryption will be realized by reading the information of the file header, and acquiring the information such as the storage location of the important data, the original location of the important data and the encryption method, so as to obtain the specific contents of the important data.

When the above described encryption method is applied to the Android platform, a file encrypted by the above described method can be backed up by the user at a fixed location of the Android system, e.g. the Privacy Safe. After the file is placed therein, the Privacy Safe will destroy the original file format of the file. The user cannot t open the encrypted file until after logging in the Privacy Safe through a pre-set verification password. If the encrypted file is searched for, but not by way of the Privacy Safe, the encrypted important data cannot be found in the file and the contents of the important data cannot be decrypted even if the encrypted file has been found.

The above are specific implementations of a file encryption and decryption method provided by the present disclosure. It can be seen from the above that the file encryption and decryption method provided by the present disclosure do not encrypt the whole file or folder, but encrypt the determined important data by selecting an important data in a file, so that an encryption operation, a local encryption is realized only for the important data in the file selected by the user through, rather than encrypting the whole file or folder. When decrypting, whether there is an encrypted important data in the source file is needed to be known and the storage location of the encrypted data is needed to be known, therefore, the difficulty of the decryption is increased. In addition, the present disclosure only perform encryption for the important data portion in a file, which improves the encryption efficiency, and can realize a function of performing encryption process rapidly for an apparatus with lower data processing capability.

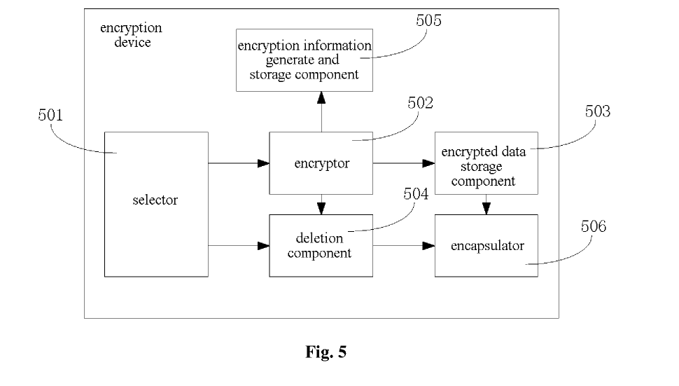

Through the above disclosed embodiments of a file encryption and decryption method of the present disclosure, corresponding to the method embodiments, the present disclosure also discloses embodiments of a file encryption and decryption devices. With reference FIG. 5, FIG. 5 is a block diagram of the embodiment of a file encryption device provided by the present disclosure. Since the embodiment of the encryption device is substantially similar to the embodiment of the encryption method, it is briefly described. The relevant description can refer to the explanation of the corresponding portion of the embodiment of the encryption method. The embodiment of the encryption device described below is merely exemplary.

The embodiment of the encryption device includes:

a selector 501 for selecting important data in a source file to be encrypted; an encryptor 502 for receiving the important data selected by the selector and encrypting the important data according to a pre-set encryption algorithm; an encrypted data storage component 503 for receiving the encrypted important data provided by the encryptor and storing the encrypted important data at a specified first location; a deletion component 504 for deleting the unencrypted important data in the source file; an encryption information generate and storage component 505 for generating encryption information according to the above encryption procedure and storing the encryption information at the specified second location, the encryption information at least including the original location of the important data in the source file.

In addition, an encapsulator 506 is included for receiving the decrypted important data and the data other than the important data in the source file and encapsulating them together into a decrypted file, and substituting the source file with the decrypted file; or encapsulating the data other than the encrypted important data into an undecrypted file, and substituting the source file with the undecrypted file.

The selector 501 has a variety of specific implementations, two of which will be given schematically below. These two specific implementations can be used separately or can be used in combination.

A first implementation is that: the selector includes a file type recognition subunit for recognizing and outputting a type of the file; a selection execution subunit for receiving the type of the file and selecting, according to the type of the file, a fixed location of the file where the important data is located.

A second implementation is that: the selector includes a specifying unit for receiving the specifying of the important data of the file by the user and selecting the important data in the file accordingly.

Alternatively, the device further includes: a file size judging unit for judging whether a size of the file is larger than a pre-set threshold, if so, sending a selection starting instruction to the selector, the selector after receiving the selection starting instruction, starting the procedure of selecting the important data in the file; and if not, sending an entirety encryption instruction to the encryptor, the encryptor after receiving the entirety encryption instruction, encrypting the whole file.

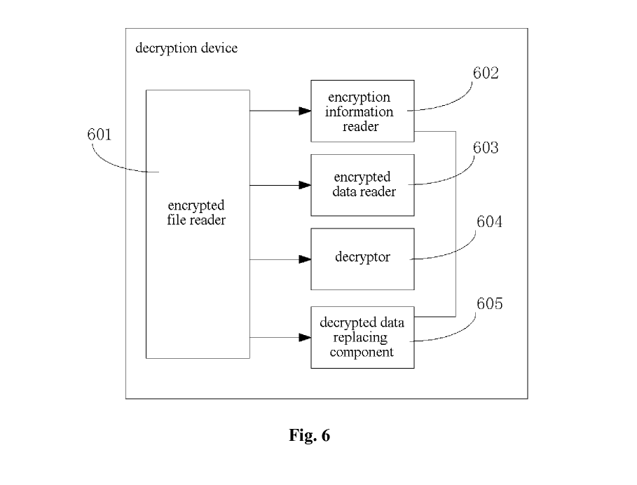

With reference to FIG. 6, FIG. 6 is a block diagram of an embodiment of a file decryption device provided by the present disclosure.

The embodiment of the decryption device includes:

an encrypted file reader 601 for reading an encrypted file, in the encrypted file only important data being encrypted;

an encryption information reader 602 for reading encryption information from a specified location, the encryption information at least including the original location of the important data in the unencrypted source file;

an encrypted data reader 603 for reading the important data in the encrypted file from the specified location;

a decryptor 604 for receiving the important data read by the encrypted data reader and decrypting the encrypted important data by using a decryption algorithm corresponding to the encryption algorithm of the encrypted important data;

a decrypted data replacing component 605 for receiving the encryption information read by the encryption information reader and according to the original location of the important data in the unencrypted source file, provided in the encryption information, replacing the decrypted important data back into the original location.

The file encryption/decryption methods and the encryption/decryption devices provided by the present disclosure have been described in detail above. The principle and embodiments of the present disclosure have been set forth by applying the specific examples in the text. The explanation of the above embodiments is only used for helping the understanding of the method of the present disclosure and the core idea thereof. Meanwhile, for those ordinary skilled in the art, depending on the idea of the present disclosure, alternations may be made in the specific implementations and application scopes. In summary, the contents of the present description should not be understood as limitation of the present disclosure.

The respective components of the embodiments of the present disclosure can be implemented in hardware, or implemented in software modules running on one or more processor, or implemented in combination thereof. It should be understood by those skilled in the art that, in practice a microprocessor or a digital signal processor (DSP) can be used to implement some or all functions of some or all components in the processing of the visual graphics coding by a mobile terminal according to the embodiments of the present disclosure. The present disclosure can also be implemented as a device or apparatus program (e.g., a computer program and a computer program product) for executing some of all of the method described here. Such a program for implementing the present disclosure can be stored on a computer readable medium or can have a form of one or more signal. Such a signal can be downloaded from an Internet website or provided on a carrier signal or provided in any other form.

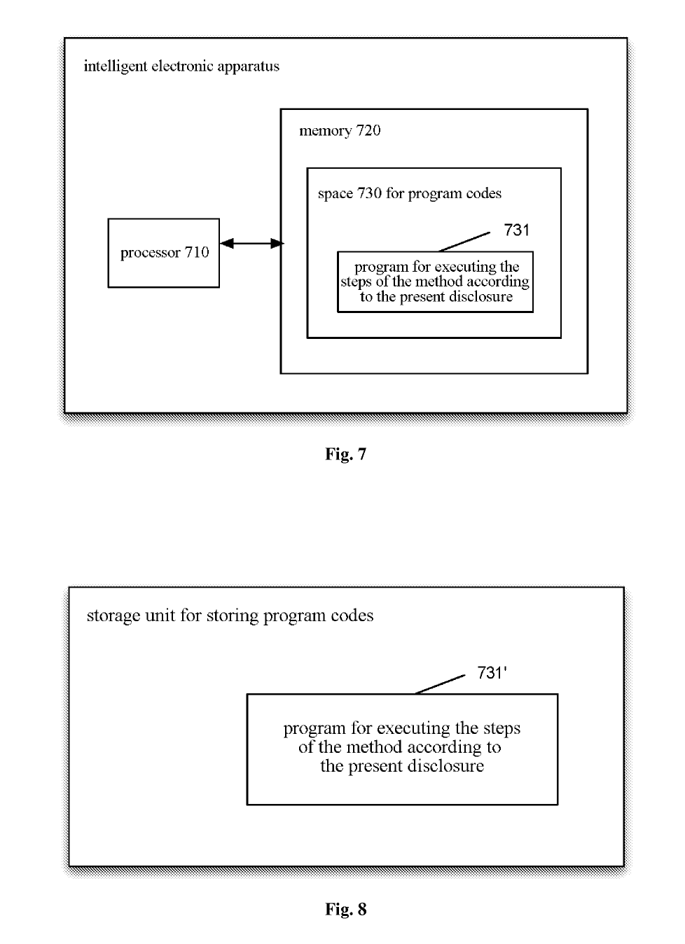

For example, FIG. 7 shows an intelligent electronic apparatus in which the file encryption method and the decryption method corresponding to the file encryption method according to the present disclosure can be implemented. The intelligent electronic apparatus traditionally includes a processor 710 and a computer program product or a computer readable medium in a form of a memory 720. The memory 720 can be an electronic memory such as a flash memory, an EEPROM (Electrically Erasable Programmable Read Only Memory), an EPROM, a hard disk or a ROM or the like. The memory 720 has a storage space 730 for program codes 731 for executing any method steps in the above method. For example, the storage space 730 for the program codes can include the respective program codes 731 for respectively implementing various steps in the above method. These program codes can be read out from or written into one or more computer program products. These computer program products include program code carriers such as a hard disk, a compact disk (CD), a memory card or a floppy disk. Such computer program products are generally portable or fixed storage units as described with reference to FIG. 8, The storage units can have storage sections, storage spaces, etc. arranged similar to those of the memory 720 in the intelligent electronic apparatus of FIG. 7 The program codes can be compressed for example in a suitable format. Generally, the storage units include program 731′ for performing the steps of the method according to the present disclosure, that is, codes that can be read by a processor for example such as 710. When these codes are run by the intelligent electronic apparatus, the intelligent electronic apparatus is caused to execute respective steps in the above described method.

1-11. (canceled)

12. A file encryption device characterized by comprising:
one or more non-transitory computer readable medium configured to store computer-executable instructions;
at least one processor to execute the computer-executable instructions to perform operations comprising:
selecting important data in a source file to be encrypted;
receiving the important data and encrypting the important data according to a pre-set encryption algorithm;
receiving the encrypted important data and storing the encrypted important data at a specified first location;
deleting the unencrypted important data in the source file;
generating encryption information according to the above encryption procedure and storing the encryption information at a specified second location, the encryption information at least including the original location of the important data in the source file.

13. The file encryption device according to claim 12 characterized by, the processor further executes the computer-executable instructions to perform operations comprising:
receiving the decrypted important data and the data other than the important data in the source file and encapsulating them together into a decrypted file, and substituting the source file with the decrypted file; or encapsulating the data other than the decrypted important data into an undecrypted file, and substituting the source file with the undecrypted file.

14. The file encryption device according to claim 12, wherein the selecting important data in the source file to be encrypted comprising:
recognizing and outputting a type of the source file;
receiving the type of the source file and selecting, according to the type of the source file, the original location of the important data in the source file and/or the encryption algorithm of the important data.

15. The file encryption device according to claim 12, wherein the selecting important data in the source file to be encrypted comprising:
recognizing and outputting a type of the source file;
receiving the specifying of the important data in the source file by the user according to the type of the file and selecting the important data in the file accordingly.

16. The file encryption device according to claim 12, the processor further executes the computer-executable instructions to perform operations comprising:
judging whether a size of the file is larger than a pre-set threshold, if so, starting the procedure of selecting the important data in the file;
and if not, encrypting the whole file.

17. A file decryption device characterized by comprising:
one or more non-transitory computer readable medium configured to store computer-executable instructions; and
at least one processor to execute the computer-executable instructions to perform operations comprising:
reading an encrypted file, in the encrypted file only important data being encrypted;
reading encryption information from a specified location, the encryption information at least including the original location of the important data in the unencrypted source file;
reading the important data in the encrypted file from the specified location;
receiving the important data and decrypting the encrypted important data by using a decryption algorithm corresponding to the encryption algorithm of the encrypted important data; and
receiving the encryption information and according to the original location of the important data in the unencrypted source file, provided in the encryption information, replacing the decrypted important data back into the original location.

18-19. (canceled)

20. A file encryption method, comprising:
determining a source file to be encrypted;
selecting important data in the source file;
encrypting the important data according to a pre-set encryption algorithm;
storing the encrypted important data at a specified first location;
deleting the unencrypted important data from the source file;
storing encryption information at a specified second location, the encryption information at least including the original location of the important data in the source file.

21. The file encryption method according to claim 20, comprising: encapsulating the encrypted important data and the data other than the important data in the source file together into an encrypted file and substituting the source file with the encrypted file.

22. The file encryption method according to claim 20, comprising: encapsulating the data other than the encrypted important data into an unencrypted file and substituting the source file with the unencrypted file.

23. The file encryption method according to claim 20 characterized in that the encryption information includes: a storage space and/or a storage location of the important data in the source file and/or encryption/decryption algorithm of the important data.

24. The file encryption method according to claim 20, the first location and the second location being a specified location of the source file or a specified location of another file, the specified location being a local or a server, the local being a mobile terminal or another computing apparatus.

25. The file encryption method according to claim 20, the important data being data which affects the proper opening of the source file, and/or data specified by a user, and/or all or a part of data of the substantial contents in the source file.

26. The file encryption method according to claim 20, when the selected important data of the source file is the data specified by a user, in this case, if the source file is a text file, the selected important data is an important paragraph in the text specified by the user; and if the source file is a graphics file, the selected important data is an important area in the graphics specified by the user.

27. The file encryption method according to claim 20, the method for selecting the important data in the source file is to recognize a file type of the source file and acquire the original location of the important data in the source file according to the file type.

28. The file encryption method according to claim 20, first it being judged whether a size of the source file is larger than a pre-set threshold, if so, proceeding to the step of selecting the important data in the source file; if not, directly selecting all of the data in the source file as the important data.
